(19) United States
(12) Patent Application Publication
(10) Pub. No.: US 2016/0198898 A1
(43) Pub. Date: Jul. 14, 2016

(54) PANCAKE BAKER AND METHOD

(71) Applicant: Heartland Food Products, Inc., Westwood, KS (US)

(72) Inventor: William R. Steeb, Kansas City, MO (US)

(73) Assignee: HEARTLAND FOOD PRODUCTS, INC., Westwood, KS (US)

(21) Appl. No.: 14/595,859

(22) Filed: Jan. 13, 2015

(51) Int. Cl. A47J 37/06; A21D 13/00

(52) U.S. Cl. CPC A47J 37/0611; A21D 13/0077

(57) ABSTRACT

A pancake making device with a pair of opposed platens that include cooperating wells for making pancakes is provided. The wells of the lower platen receive a quantity of pancake batter. The platens are then closed and rolled over so that the batter spreads across the well of the engaged well. Rolling over the platens engages a control system that heats the platens such that the batter rises to fill both of the engaged wells, and thereby cooks and forms a cooked pancake. When the cooking is complete, the control system sounds a beeper that signals the user to roll the platens over to the starting position, so that the platens can be opened and the pancake removed.

### BACKGROUND OF THE INVENTION

The present invention relates to a pancake making device. More particularly, the present invention relates to a cooking assembly, with a clam shell arrangement of cooking surfaces, which is rotated on a stand between a first position associated with not cooking and a second position associated with cooking, as well as a method thereof that uses the pancake baker to cook both side of a pancake simultaneously.

Electric griddles and similar cookware for cooking pancakes, waffles, and the like are well known. These devices are generally constructed with either one or two heating plates that are typically secured to a housing and typically heated by electrical resistance heaters.

Prior art griddles that have a single cooking plate require that each side of the food be cooked separately, with the food being flipped over after cooking the first side of the food, so that the second side can be cooked. Since the two sides of the food are not cooked simultaneously, they may cook different lengths of time, and therefore unevenly, and the food may fall apart during the flipping between the first and second food sides.

Prior art griddles that have two cooking plates are typically hinged between the plates so that the griddle can be turned from a first position where a first of the plates located below a second of the plates to a second position where the first plate is located above the second plate. Such prior art griddles are used by cooking the first side of the food on the first plate and then flipping the food onto its second side onto the second plate, so that the food second side can be cooked. While this hinged configuration may reduce problems of the food breaking during the flipping step, since the two griddles are closed together, these devices still have the problem of each side of the food being cooked separately, which leads to uneven cooking on the two sides of the food.

In commercial and institutional settings, such as hotels and college and hospital cafeterias, it is popular to allow the consumer to cook his or her own waffles. Pancakes are generally preferred over waffles by adults. However, pancakes are not amenable to these settings because the prior art griddle devices are too complex and time consuming for the consumer and take up too much counter space in the small area provided for such activities in these settings.

Therefore, there is a need for a quick and simple to use pancake making device for use in commercial and institutional settings.

### SUMMARY OF THE INVENTION

The present invention provides improvements in a batter based food product, or pancake, cooking device which includes a pair of opposed cooking plates which are selectively heated and which are mounted on a support frame. Each of the cooking plates has one or more recessed cooking wells, and the wells of each plate are aligned with corresponding wells of the other plate to form cooking chambers when the plates are brought together. The cooking plates are pivotally supported on the support frame in such a manner that the cooking plates form a cooking assembly which can be flipped 180 degrees about a horizontal axis. The cooking chamber has a selected depth such that a selected volume of a batter received in the chamber is simultaneously cooked on both sides after the cooking assembly is flipped 180 degrees to form the cooked food product.

More particularly, the present invention is directed to a pancake baking or cooking device including opposed upper and lower platens. Each of the platens includes a body with inner and outer surfaces and pancake cooking wells recessed into the inner surface. A hinge connects the upper and lower platens such that the platen inner surfaces are directed toward one another and so that the upper platen is pivotally movable between a closed configuration engaging the lower platen and an open configuration. In the closed configuration corresponding pancake wells in the platens align to form pancake cooking chambers.

The platens are engaged with respective hot plate type structures having electrical resistance heating elements therein which, when activated heat the platens to cook pancake batter positioned within the cooking chambers. The platens, hot plate structures, and hinge form a cooking assembly which is mounted on the pancake cooking device to enable the assembly to be rolled or flipped 180 degrees about a horizontal axis between a non-cooking position and a cooking position.

The pancake cooking device includes control circuitry including a processor or controller which controls electrical activation of the heating elements in such a manner as to maintain a desired heating temperature. Heat sensors engage the platens and are interfaced to the processor to enable the processor to maintain the temperature. The processor may include audible and/or visual indicators to indicate operating states of the cooking device. A flip switch is engaged with the cooking assembly to detect the flipping of the assembly. The processor includes a timer circuit or a timer process to time cooking of pancakes by the device.

A measured quantity of pancake batter is poured into the pancake wells of the lower platen with the cooking assembly in the non-cooking position, and the upper platen is closed, thereby aligning the pancake wells of the upper platen with corresponding wells in the lower platen. The cooking assembly is flipped to the cooking position, thereby causing the flip switch to initiate the timer and causing the processor to activate the heating elements to heat to a cooking temperature. When the timer times out, an indicator, such as a beeper, alerts the user to flip the cooking assembly to the non-cooking position and remove the cooked pancakes from the pancake wells. End surfaces of the pancake wells can be patterned to form surface patterns on the cooked pancakes.

Other advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a pancake baking device of the present invention with upper and lower pancake making platens disposed in a closed position.

FIG. 2 is a perspective view of the pancake baking device with the upper and lower platens disposed in an open position.

FIG. 3 is a perspective view of the pancake baking device with the upper and lower platens disposed in closed and 180° rotated position about an axis A.

FIG. 4 is an enlarged perspective view of an exemplary cooked food product made using the pancake baking device of the present invention.

FIG. 5 is an enlarged top plan view of a platen of the pancake baking device.

FIG. 6 is an enlarged fragmentary perspective view of a cooking well of a platen of the baking device.

FIG. 7 is an enlarged fragmentary cross-sectional view of a lower platen of the pancake baking device taken along line 7-7 of FIG. 1, and also showing pancake batter being poured into a well of the lower platen.

FIG. 8 is a fragmentary cross-sectional view of the upper and lower platens of the pancake baking device of FIG. 3, taken along line 8-8 of FIG. 3.

FIG. 9 is a view similar to FIG. 8 illustrating cooked pancake batter filling the pancake making chamber formed by the closed platens.

FIG. 10 is a block diagram illustrating exemplary control system for the pancake baking device of the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 10 generally designates a pancake making apparatus or device, griddle, or “iron”, according to the present invention, which is referred to herein as a pancake maker 10. The pancake maker 10 is somewhat similar to the waffle maker disclosed in U.S. Pat. No. 5,937,742 and to the device disclosed in U.S. Provisional Patent Application No. 62/022,375, entitled WAFFLE PANINI PRESS AND METHOD and filed on Jul. 9, 2014, both of which are incorporated by reference herein in their entirety.

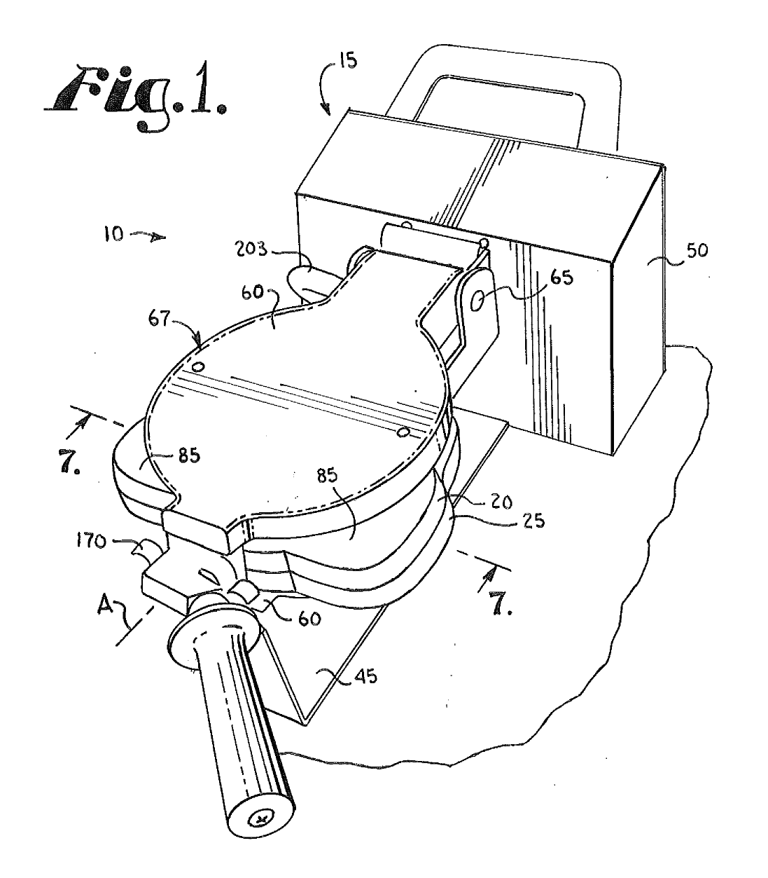

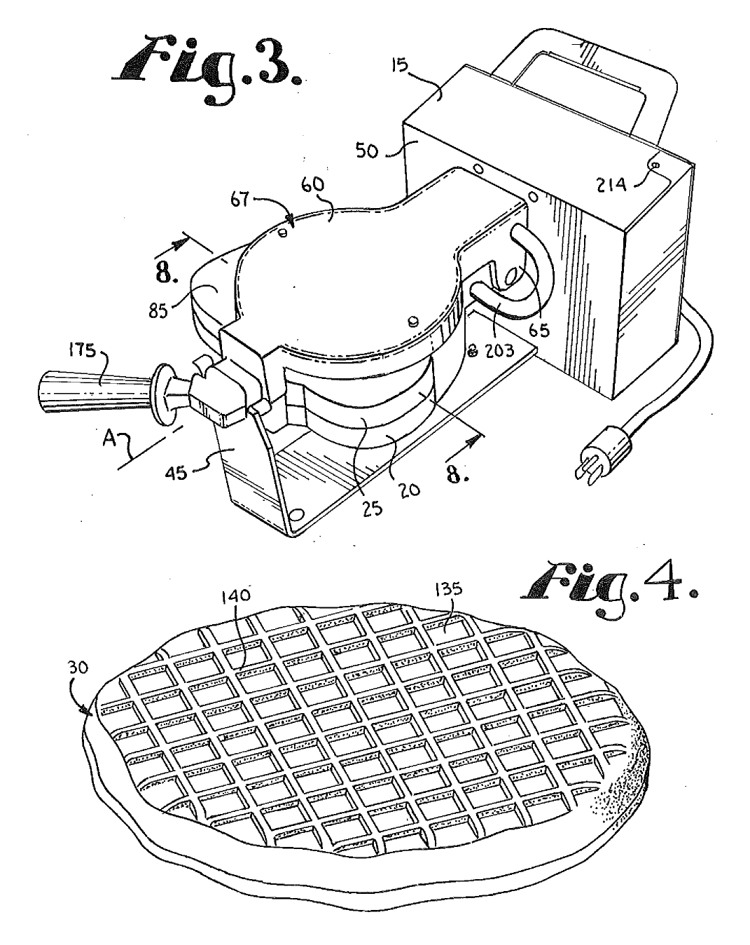

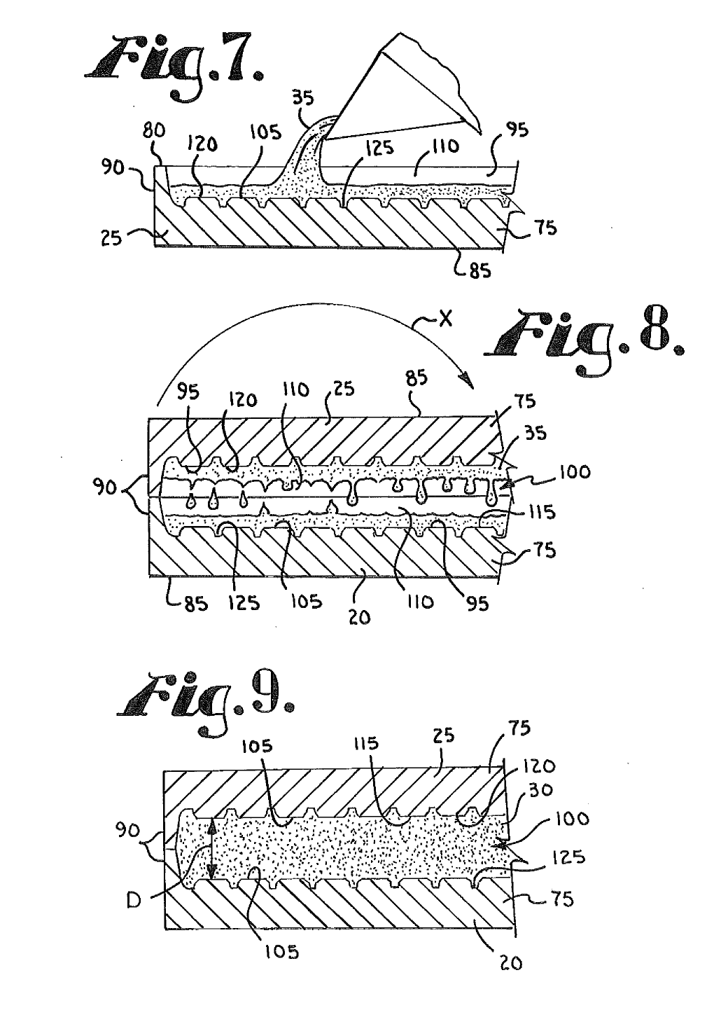

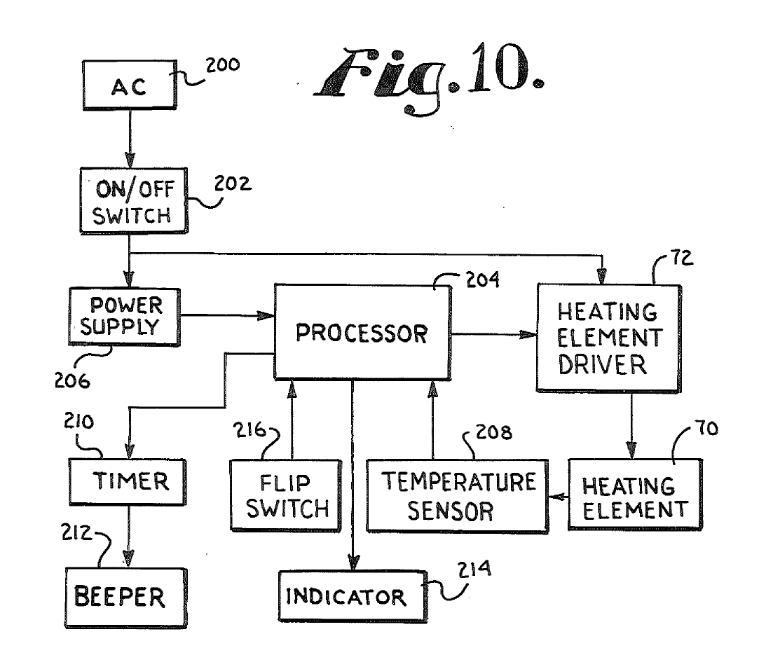

Referring now to FIGS. 1-3, the pancake maker 10 includes a support framework or base, generally 15, and a pair of upper and lower platens or cooking plates 20 and 25 respectively. The pancake maker 10 is configured and arranged for a user to make a cooked pancake type food product 30 (FIGS. 4 and 9) from un-cooked batter 35 (FIGS. 7-8). The pancake maker 10 includes a control system, generally 40 (see FIG. 10), that automates aspects of cooking of the pancake 30 so as to be simply and easily operated by a user with no special training.

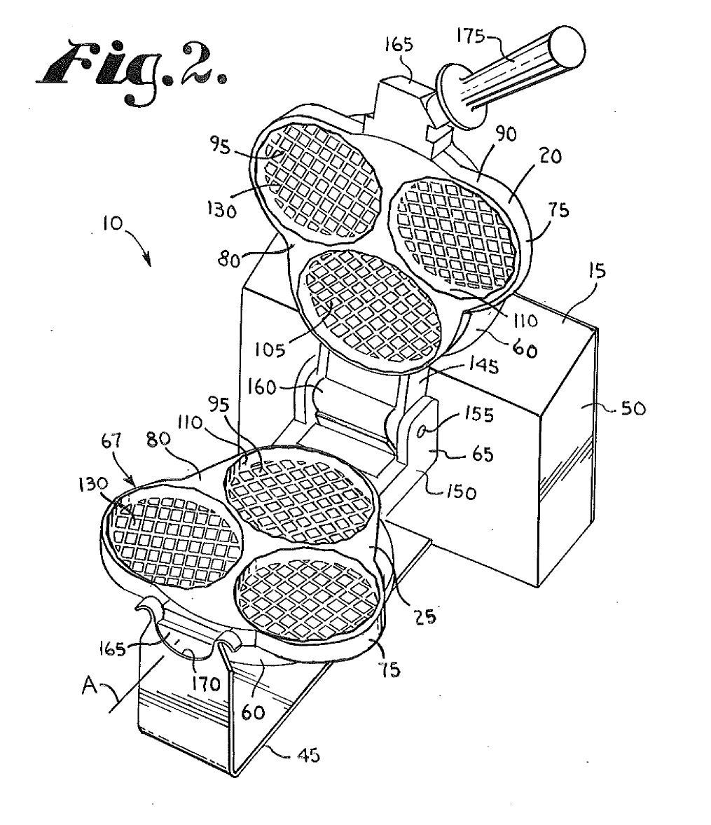

The base 15 includes a stand 45 and a housing 50 that are intersected by a horizontal axis A (FIGS. 1 and 2), which is substantially parallel with a surface 55 that supports the base 15. The housing 50 contains at least some components of a control system 40, which is described in greater detail below.

The stand 45 supports a pair of hot plate structures or hot plates 60 that are pivotally joined by a hinge 65 in an opposed or clam-shell configuration so that the hot plate structures 60 can be moved between a closed configuration or position (FIGS. 1 and 3) and an open or opened configuration (FIG. 2). A pivoting structure (not shown) joins the hinge 65 with the housing 50 such that the hinge 65 and the hot plates 60 can be reversibly rolled, flipped, turned over, or pivoted about the axis A, between a non-cooking position or configuration (FIG. 1) and a cooking position (FIG. 3). The hot plate structures 60 form a cooking assembly 67 along with the hinge 65 which is flipped about the axis A for cooking. As discussed in greater detail below, moving the hot plates 60 between the non-cooking and cooking positions is essential for evenly cooking the pancake 30.

As noted above, the pancake maker 10 includes an upper platen 20 and a lower platen 25. The platens 20, 25 are removably attached to respective hot plate structures 60 so as to be opposed to one another, such as is shown in FIG. 1-3. Since the hot plate structures 60 are hingedly connected to each other, the attached platens 20, 25 are also movable between the closed and opened configurations and between the non-cooking and cooking configurations described above and shown in FIGS. 1-3.

Each hot plate 60 includes a heating element which is denoted by box 70 in FIG. 10. When actuated by a heating element driver 72 (see FIG. 10), the heating elements 70 heat the respective platen 20, 25 to a selected cooking temperature for a selected period of cooking time. The cooking temperature and the cooking time are selected so as to cooperate with a selected quantity of batter 35, so as to produce a fluffy and tender pancake 30. The platens 20, 25 are fabricated of a metal of other heatable material, such as is known in the art, so as to be quickly and efficiently heated by the respective hot plates 60. Suitable cooking temperatures may range from about 350° F. (175° C.) to about 450° F. (235° C.). The length of cooking time that the platens 20, 25 are heated depends upon the cooking temperature used to cook the pancake 30 and the volume of batter 35 being cooked. For example, depending upon the selected cooking temperature, suitable cooking times may range from about 90 seconds to about 3 minutes. It is foreseen that longer or shorter cooking times may be used, depending upon the temperature of the platens 20, 25. In an exemplary embodiment, the platens 20, 25 are heated to 390° F. (200° C.) for 2.5 minutes, so as to cook 6 ounces (170g) of a pancake batter 35.

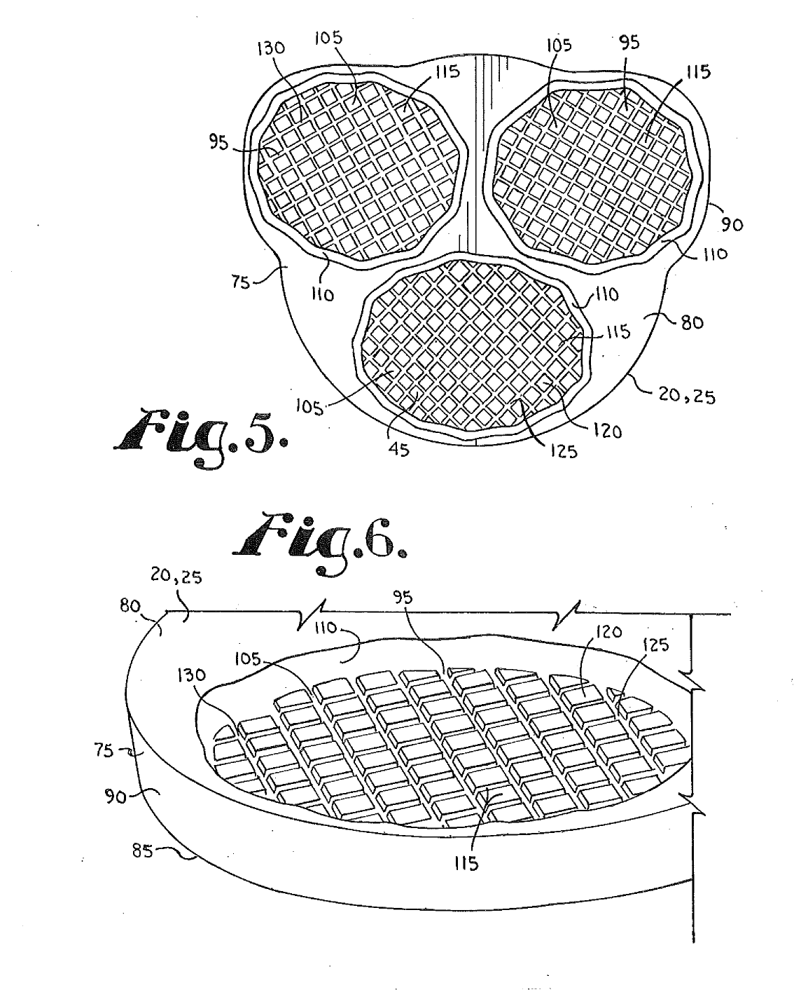

Referring now to FIGS. 5-6, each of the platens 20, 25 includes a body 75 with an inner surface 80 and an outer surface 85. A side surface 90 joins the inner and outer surfaces 80, 85. The body is fabricated of a heatable and coolable material, such as a heat conductive metal or other such materials known in the art. At least some of the surfaces 80, 85 and 90 may be coated with a non-stick coating, such as is known in the art, to prevent batter 35 and a cooked pancake 30 from sticking thereto.

The platens 20, 25 are fastened to the hot plate structures 60 such that the outer surfaces 85 engage a respective hot plate 60 and the platen inner surfaces 80 face one another (see FIGS. 1-3). When in the closed position (see FIGS. 1 and 3), the platen inner surfaces 80 cooperatively contact and engage one another.

Referring to FIGS. 2 and 5-9, each platen 20, 25 includes at least one recessed pancake well or form 95 that is sized and shaped to receive a quantity of pancake batter 35 so as to make a pancake-shaped cooked pancake food product 30, which is generally circular or ovular when viewed from above (see FIG. 4). In some embodiments, the volume of batter 35 may be about is 6 ounces. In other embodiments, the wells 95 may be sized to receive more or less than 6 ounces of batter 35. The wells 95 may be coated with a non-stick material, such as is known in the art, to facilitate removal of the pancake 30 after cooking. In the illustrated embodiment, each of the platens 20, 25 includes three pancake recession wells 95, with two of the wells 95 being somewhat circular and a third well 95 being more ovate than the others. The wells 95 are inset into the inner surface 80 of the respective platen 20, 25. Further, the wells 95 are sized and spaced apart, or located, such that when the platens 20, 25 are in the closed configuration (FIGS. 1 and 3 and 8-9) the platen inner surfaces 80 are cooperatively engaged and the opposed pancake wells 95 of the upper and lower platens 20, 25 align as to form pancake cooking chambers 100 (FIGS. 8-9).

It is noted that when the platens 20, 25 are in the open configuration shown in FIG. 2, the inner surfaces 80 are spaced apart a distance sufficient for a user to pour a quantity of batter 35 into the well 95 of the lower platen 25 (see FIGS. 2 and 7). After the user has poured batter 35 into at least one of the wells 95, the user closes the platens 20, 25 so as to form the pancake cooking chambers 100 (FIGS. 8-9).

Still referring to FIGS. 2 and 5-9, each of the wells 95 includes a bottom portion or pancake-making end surface 105 joined to the respective platen inner surface 80 by a curvate pancake making side surface 110. The side surface 110 may be irregularly shaped so as to mimic a pancake cooked on a griddle. The side surface may also be slanted and fluted, and may include additional irregularities.

The side surfaces 110 include a height. When the cooking chamber 100 is formed, the side surfaces 110 of the engaged wells 95 provide a distance D (see FIGS. 8-9) between the surfaces 105 of the aligned wells 95. The distance D separates the opposed pancake-making surface 105, such that the batter may rise during cooking pancakes so that the product 30 (see FIGS. 8-9) becomes fluffy and tender, such as is typical of pancakes known in the art, but not of waffles which are generally crispy. In an exemplary embodiment, the pancake-making surfaces 105 may be spaced apart a distance D of about 0.625-inches (16 mm). It is foreseen that the distance D may be slightly more or less than 0.625-inches, so long as the resulting pancake 30 is suitably cooked.

In some embodiments, the pancake-making surface 105 may be flat and smooth, so that the cooked pancake 30 has smooth upper and lower surfaces. In other embodiments, at least one of the pancake-making surfaces 105 may include a shallow pattern 115 that is sized and shaped to provide a design on a surface of the cooked pancake food product 30. Such a pattern 115 can include raised or embossed portions 120 and recessed or relieved portions 125 (FIGS. 6-9). In an exemplary embodiment, the pattern 115 may be a grid pattern 130 (FIGS. 5-6) that produces shallow recesses 135 on the surface 140 of the pancake 30 (FIG. 4) that prevents syrup from running off of the pancake 30. It is foreseen that the pattern 115 can include other shapes or designs. For example, the pattern 115 may include a decorative shape, such as a flower or smiley face, or a logo of a hotel or restaurant. It is also foreseen that the pancake wells 95 can be alternatively decoratively shaped, so as to produce a decorative pancake 30 in the shape of a flower, an animal, a smiley face and the like. The platens 20, 25 may be unfastened and removed from the hot plate structures 60, as needed. Therefore, it is foreseen that sets of platens 20, 25 with various designs, such as seasonal or holiday designs, may be interchangeable.

Referring again to FIGS. 1-3, the hinge 65 can be opened and closed, depending upon the cooking position of the platens 20, 25. In particular, as shown in FIGS. 1-2, the hinge is reversibly openable when the pancake maker 10 is in a non-cooking position. However, when the closed platens 20, 25 are flipped about the axis A, the hinge 65 prevents the pancake maker 10 from being opened. With reference to FIG. 2, the hinge 65 includes movable and fixed components 145, 150 respectively that are pivotally joined by an axle or binge pin 155. The hinge components 145, 150 each include a metal flashing or cover 160 that prevents batter 35 from getting into the hinge 65 and clogging it up.

The hot plates 60 each include a stand engagement member 165 opposed to the hinge 65. The stand engagement members 165 have curved outer surfaces which pivotally engage a curved front end bearing 170 of the stand 45. The stand engagement members 165 and bearing 170 form one end of a pivot structure to enable the cooking assembly 67 to be flipped about the axis A. An opposite end (not shown) of the pivot structure is mounted within the housing 50. The stand engagement member 165 of the upper hot plate 60 includes a handle 175 extending therefrom. The user uses the handle 175 to open and close the platens 20, 25 and to flip the platens about the axis A.

Referring to FIG. 10, the pancake batter 35 in the device 10 is cooked by heat from the resistance heating elements 70 positioned within the hot plate structures 60 of the cooking assembly 67 to thereby heat the cooking platens 20 and 25. The heating elements 70 may be powered by alternating current (AC), such as from an AC source or outlet 200 by way of an on/off or power switch 202 and the heating element driver 72 of the control circuitry 40. The heating elements 70 may be connected in parallel for simultaneous operation by power conductors (not shown) which are positioned within a protective, flexible conductor sheath 203 (FIG. 1). In the illustrated circuitry 40, the driver 72 may be a solid state power controller such as a properly rated power transistor, a thyrister, or a triode for AC (TRIAC), by an electromagnetic relay, or by a similar power control component which is activated by a controller or processor 204 of the circuitry 40. A low voltage power supply 206 provides the required voltage or voltages to the processor 204 and receives power from the AC outlet 200.

The processor 204 is programmed to control operation of the baking device 10. The illustrated processor 204 controls the temperature of the heating elements 70 by the use of temperature sensors 208 which are in thermal communication with the heating elements 70. The processor 204 also controls the cooking time by the operation of a timer 210 which may, although shown as a separate component in FIG. 10, may be a programmed process within the processor 204. The circuitry 40 may also incorporate a sonic alert, such as a beeper 212, and/or a visual alert or indicator 214, such as a light bulb, a light emitting diode (LED), or an alphanumeric display (not shown). A flip switch 216 is interfaced to the processor 204 is positioned within the housing 50 and engages the cooking assembly 67 in such a manner as to detect whether the assembly 67 is in the non-cooking position or has been flipped about the axis A to the cooking position.

In an embodiment of the pancake baking device 10, when the circuitry 40 is connected to the AC source 200 and the power switch 202 is operated, the processor 204 causes the heating elements 70 to heat up the cooking platens 20 and 25 to a desired preheat temperature. When the desired preheat temperature is reached, the indicator 214 may be illuminated and the beeper 212 sounded to indicate readiness for cooking. When pancake batter 35 is placed in the wells 95, the upper platen 20 closed over the lower platen 25, and the cooking assembly 67 flipped to the cooking position, the flip switch 216 causes the timer 210 to initiate and for the processor 204 to heat the platens 20 and 25 to a cooking temperature higher than the preheat temperature for a length of time to properly cook the batter 35. The indicator 214 may, for example, blink to indicate that the cooking cycle is occurring. When the timer 210 times out, the beeper 212 sounds and the processor 204 controls the heating elements 70 to cause the temperature of the platens 20 and 25 to coast back to the preheat temperature. At this time, the user flips the cooking assembly 67 back to the non-cooking position, raises the upper platen 20, and removes the cooked pancakes 30 from the device 10. Alternatively, other configurations of circuitry 40 and methods of operation thereof for the device 10 are foreseen.

A method of making a cooked pancake food product 30 with a pancake making device 10 having a pair of platens 20, 25 with cooperatively engageable recessed pancake forms 95, wherein a first of the forms 95 includes a first bottom surface 105 and a second of the forms 95 includes a second bottom surface 105, the method comprising pouring a quantity of batter 35 into the first form 95 such that the batter 35 spreads across the first bottom surface 105 (FIG. 7); placing the platens 20, 25 in a closed position (FIG. 1) such that the first and second forms 95 are cooperatively engaged and aligned to form pancake cooking chambers 100 with the first and second bottom surfaces 105 spaced apart from each other; flipping the closed platens in a first direction denoted by the arrow X (FIG. 8) about the axis A such that a portion of the batter spreads 35 across the second bottom surface 105 (FIG. 8); and heating the platens 20, 25 such that the batter 35 on the first and second bottom surfaces 105 rises and fills the pancake cooking chamber 100 (FIG. 9), whereby the cooked pancake food product 30 is produced.

In a further embodiment, the step of flipping the closed platens 20, 25 in the first direction X includes actuating a control assembly 40 (FIG. 10).

In a further embodiment, the method includes actuating a timer 210, and actuating a heating element 72 engaged with each of the platens 20, 25 whereby the platens are 20, 25 heated to a cooking temperature, such as described above.

In a further embodiment, the step of placing the platens 20, 25 in a closed position (FIG. 1, 3, 8-9) includes spacing apart the first and second bottom surfaces 105 a distance D of about 0.625 inches.

In a further embodiment, the step of pouring a quantity of batter 35 into the first form 95 includes pouring about 6 ounces of batter 35 into the first form 95.

In a further embodiment, the method includes the steps of rolling the closed platens 20, 25 in a direction reverse to the direction X; and placing the platens 20, 25 in an open position (FIG. 2) so as to disengage the first and second forms 95 from the cooked pancake 30.

In a further embodiment, the step of pouring a quantity of batter 35 into the first form 95 includes pouring another quantity of batter 35 into another form 95 of the first platen 20.

It is to be understood that while certain forms of the present invention have been illustrated and described herein, it is not to be limited to the specific forms or arrangement of parts described and shown.

1. In a batter based food product cooking device including a pair of opposed cooking plates which are selectively heated and which are mounted on a support frame, the improvement comprising:
each of the cooking plates having a recessed cooking well the well of each cooking plate being aligned with the recessed cooking well of the other cooking plate and forming a cooking chamber therewith when the cooking plates are brought together;
the cooking plates being pivotally supported on the support frame in such a manner that the cooking plates form a cooking assembly which can be flipped substantially 180 degrees about a horizontal axis; and
the cooking chamber having a selected depth whereby a selected volume of a batter received in the cooking chamber is simultaneously cooked on both sides after the cooking assembly is flipped 180 degrees to form the cooked food product, wherein the cooked food product is a pancake.

2. The improvement as set forth in claim 1 wherein:
each cooking well has an end surface; and
each end surface has a surface pattern to thereby form a pattern on the cooked food product.

3. The improvement as set forth in claim 1 wherein:
each cooking well has a side surface; and
each side surface has a pancake shape to thereby form the cooked food product to the pancake shape.

4. The improvement as set forth in claim 1 wherein:
each cooking plate has a plurality of cooking wells recessed therein; and
corresponding cooking wells of the cooking plates are aligned when the plates are brought together to form a plurality of cooking wells to enable a plurality of cooked food products to be simultaneously cooked.

5.-28. (canceled)

29. A batter-based cooking device comprising:
a first and second cooking plate, the first and second cooking plates mounted on a support frame opposing one another and movable between an open configuration and a closed configuration;
the first and second cooking plates pivotably transposable on the support frame;
wherein the first and second cooking plates, when in the closed configuration, pivot about a horizontal axis between a cooking position and a non-cooking position,
the non-cooking position having the first cooking plate above the second cooking plate,
and the cooking position having the second cooking plate above the first cooking plate;
each of the cooking plates further having a recessed cooking well, the recessed cooking well of at least one of the cooking plates substantially disc-shaped and of uniform depth;
the recessed cooking wells of the first and second cooking plates, when in the closed configuration, forming a pancake-shaped cooking chamber; and
at least one heating element coupled to the first and second cooking plates, the at least one heating element heating the cooking plates when the cooking chamber is in the cooking position.

30. The hatter-based cooking device of claim 29, wherein each of the cooking plates has at least two recessed cooking wells.

31. The batter-based cooking device of claim 29, further comprising a syrup-retaining pattern on at least one of the recessed cooking wells, the patterned recessed cooking well maintaining the substantially uniform depth.

32. The batter-based cooking device of claim 29, wherein each of the recessed cooking wells have a bottom and the bottom of the first recessed cooking well is spaced 0.625 inches apart from the bottom of the second recessed cooking well when in the closed configuration.

33. The batter-based cooking device of claim 29, comprising:
the at least one heating element activated when the cooking plates are pivoted to the cooking position; and
a timer controllably coupled to the at least one heating element, the at least one heating element deactivated when a preset time elapses.

34. The pancake cooking device of claim 29, wherein the pancake-shaped cooking chamber is one of circular or ovular on at least one surface.
